(19) United States
(12) Patent Application Publication
(10) Pub. No.: US 2014/0012761 A1
(43) Pub. Date: Jan. 9, 2014

(54) METHOD FOR OPERATING A CASH BOX WITH CUSTOMER-SPECIFIC KEYS

(71) Applicants: Christoph Schmidt, Detmold (DE); Sascha Ringel, Rietberg (DE)

(72) Inventors: Christoph Schmidt, Detmold (DE); Sascha Ringel, Rietberg (DE)

(73) Assignee: WINCOR NIXDORF INTERNATIONAL GMBH, Paderborn (DE)

(21) Appl. No.: 14/006,361

(22) PCT Filed: Mar. 21, 2012
(86) PCT No.: PCT/EP12/54979

§ 371 Date: Sep. 20, 2013

(30) Foreign Application Priority Data
Mar. 21, 2011 (DE) 10 2011 001 430.6

(51) Int. Cl. G06Q 20/36

(52) U.S. Cl. CPC G06Q 20/3674
USPC 705/50

(57) ABSTRACT

The invention relates to a process for operating a cash box (10), in which in a memory element (18) of a control unit (14) of the cash box (10) program data of a production bootstrap loader for booting the cash box (10) and a production key (P) for encrypting data sent by the cash box (10) and/or for decrypting received data are factory-stored. For commencing operation the cash box (10) is inserted in a device (30, 54, 62, 72) for receiving cash boxes (10). A data transmission connection is established to the cash box (10). The program data of the production bootstrap loader are replaced by program data of an operation bootstrap loader for booting the cash box (10) and the production key (P) is replaced by a client-specific operation key (A, B, C, D).

### CROSS-REFERENCE TO RELATED APPLICATIONS

This application is a National Stage of International Application No. PCT/EP2012/054979, filed Mar. 21, 2012, and published in German as WO 2012/126937 A1 on Sep. 27, 2012. This application claims the benefit and priority of German Application No. 10 2011 001 430.6, filed Mar. 21, 2011. The entire disclosures of the above applications are incorporated herein by reference.

### BACKGROUND

This section provides background information related to the present disclosure which is not necessarily prior art.

1. Technical Field

The invention relates to a process for operating a cash box, in which in a memory element in a control unit of the cash box program data of a production bootstrap loader for booting the cash box and a production key for encrypting data sent by the cash box and/or for decrypting received data are factory-stored.

2. Discussion

The cash box is in particular inserted in devices for handling notes of value, such as automatic cash systems, automatic cash safes and/or automated teller machines, as well as in docking stations in cash centers. When the cash box is inserted in one of the above-mentioned devices, a data communication connection is established between the cash box and the device, via which data can be transmitted between the device and the cash box. In particular, data can be transmitted via which adjustments of the cash box, such as for example the activation and deactivation of devaluating units, such as for example ink kits, for devaluating notes of value received in the cash box, can be adjusted. In particular, the criteria when such a devaluating unit is activated, can be changed. Further, it is possible to adjust and change timers, which are available for individual process steps during the handling of the cash box.

To protect the transmission of such security relevant data and thus prevent manipulation attempts, the data transmitted between the devices and the cash box are encrypted. A process for encrypting the transmitted data is for example known from Document DE 10 2009 032 355. A problem of this known encryption process is that due to the use of a uniform production key everybody who knows these production keys, could decrypt the data of all cash boxes in circulation and thus change the adjustments of the cash boxes. The operators of the cash boxes, i.e. the clients, adapt the security relevant adjustments in particular to their individual circumstances. By the use of such a uniform production key, cash boxes of one client can also be inserted in the device of another client, so that this other client could change the adjustment of the one client.

From the not pre-published Document DE 10 2010 061 070 it is known to use several keys for different device groups.

### SUMMARY OF THE INVENTION

It is an object of the invention to specify a process for operating a cash box, by means of which operating of the cash box being safe against manipulation is possible.

According to the invention after its manufacture for commencement of operation the cash box is inserted in a device for receiving cash boxes and a data transmission connection between this device and the cash box is established. Subsequently, the program data of the production bootstrap loader are replaced by program data of an operation bootstrap loader for booting the cash box and the production key is replaced by a client-specific operation key for encrypting the data sent by the cash box and/or for decrypting received data.

By using client-specific operation keys, by means of which the communication between the cash box and the devices for handling notes of value of the client, in which the cash box shall be inserted, is encrypted, it is achieved that the cash box can only be operated in these devices of this one client. In particular, hereby it is achieved that adjustments of the cash box, in particular security adjustments, such as for example the adjustments of devaluating units, can only be changed by the operator of the cash boxes, i.e. the client. Thus, a high level of security is achieved. The replacement of the production bootstrap loader by the operation bootstrap loader ensures that the firmware of the cash box cannot be changed by unauthorized persons, so that the encryption via the client-specific operation key cannot be avoided. The clients are in particular banks and credit institutions.

By replacing the program data of the bootstrap loader or, respectively, replacing the key it is generally understood that after the replacement only the operation bootstrap loader can still be used for booting the cash box and only the client-specific operation key can still be used for the communication. Hereby, in particular the program data of the production bootstrap loader are replaced by the program data of the operation bootstrap loader and/or the production key is overwritten by the client-specific operation key. Alternatively, the corresponding data can also not be overwritten, but the data of the production bootstrap loader and the production key can still remain stored in the memory element of the cash box. In this case, the program data of the operation bootstrap loader and the client-specific operation key are additionally stored in the memory element. The production bootstrap loader and the production key lose their validity, so that for booting only the operation bootstrap loader can still be used and for the encryption only the operation key can still be used.

The device for receiving cash boxes, in which the cash box is inserted for commencement of operation, is in particular a so-called docking station, via which a data transmission connection to the cash box is establishable. This data transmission connection is in particular formed via a plug connection. Alternatively, the data transmission can also take place wireless, e.g. via WLAN or radio. A docking station is in particular understood to be a device in which the cash box is inserted for filling and/or emptying in a secured environment, for example a cash center.

The production bootstrap loader is in particular replaced by a client-specific operation bootstrap loader. Alternatively, the production bootstrap loader can also first be replaced by a standard operation bootstrap loader, wherein then subsequently data with information about the client-specific operation key are transmitted via the data transmission connection from the device to the cash box and the production key is replaced by the client-specific operation key. By this transmission of the client-specific operation key then the standard operation bootstrap loader also becomes a client-specific bootstrap loader. Thereby it is achieved, that a standard operation bootstrap loader can first be stored uniformly in the memory elements and still operating of the cash box is only possible in the devices for handling notes of value of this one client due to the client-specific individualization by the operation key.

The program data of the operation bootstrap loader, the data with the information about the client-specific operation key and/or the client-specific operation key are preferably first encrypted by the device by means of the production key and are transmitted as encrypted data via the data transmission connection to the cash box. The control unit of the cash box subsequently decrypts these encrypted data by means of the production key and replaces the production bootstrap loader and/or the production key hereby. Thus, a secure data transmission is achieved, so that manipulations in the data transmission and thus potential subsequent manipulations of the cash box are prevented. In particular, it is hereby achieved that also actually that client-specific operation key is stored, which also should be stored.

The client-specific operation key is preferably also stored in a memory element of at least one device for handling notes of value, in which the cash box shall be inserted during operation. During the communication between the device and the cash box inserted therein the transmitted data are encrypted by means of this client-specific operation key. Thus, it is achieved that the cash box can only be operated in those devices for handling notes of value, for which it is determined. In particular, in all devices for handling notes of value, in which the cash box shall be inserted during operation, the client-specific operation key is stored in respectively one memory element.

The encryption of the data transmitted between the device for handling notes of value and the cash box during operation and/or the encryption of the data transmitted by the device for receiving cash boxes and the cash box upon commencement of operation takes in particular place by means of a block encryption algorithm. Thus, an easy but still secure encryption is achieved. In particular, a blowfish encryption algorithm, an advanced encryption standard (AES) encryption algorithm, a data encryption standard (DES) encryption algorithm and/or an extended tiny encryption algorithm (XTEA) is used.

In a preferred embodiment of the invention, several client-specific operation keys are stored in the memory element of the cash box. In the memory element of several devices for handling notes of value respectively at least one of these operation keys is stored, wherein the communication between one of these devices and the cash box inserted in this device takes place such that the transmitted data are transmitted in an encrypted manner by means of the corresponding client-specific operation key stored in the memory element of the device and the memory element of the cash box. Thus, it is achieved that the cash box can be operated in the devices for handling notes of value of several clients and thus several device groups.

Further it is advantageous, if the data are transmitted between the cash box and the device for handling notes of value in which the cash box is inserted in a so-called challenge response process. Such a challenge response process is for example known from Document DE 10 2009 032 355 A1. The procedure of the challenge response process is herewith incorporated into the present description by reference.

In a particularly preferred embodiment of the invention, the challenge response process comprises at least the following five steps: In a first step, data with information for the request of a random number are transmitted from the device for handling notes of value in the cash box inserted therein via the data transmission connection. Subsequently, in a second step, the cash box generates a random number by means of a random number generating algorithm stored in the control unit and encrypts this random number before the cash box transmits it to the device via the data transmission connection. In a third step, the device decrypts the encrypted random number and generates data with at least one control command, wherein these data comprise the random numbers. Subsequently, in the fourth step the device encrypts these data with the client-specific operation key and transmits the encrypted data to the cash box. In a fifth step, the cash box decrypts the data transmitted to it by means of the client-specific operation key and compares the random number contained in the decrypted data with the random number, which was generated by the random number generating algorithm in the second step.

If this comparison shows that the generated random number and the random number transmitted in the fourth step are identical, the cash box executes the transmitted control command. However, if the comparison shows that the random numbers are not identical, the cash box does not execute the control command. In particular, the cash box generates in this case an error message and stores the data with information about this error message in a memory element and/or transmits data with information about this error message to the device, in which the cash box is received. This cash box in return shows in particular the error message via a display unit.

By the above-described challenge response process a very secure data transmission between the device and the cash box inserted therein is achieved. By the encryption with the client-specific operation key it is further achieved, that the communication between the cash box and the device is only possible, if this client-specific operation key is both stored in the memory element with the cash box and in the memory element of the device. Thus, the cash box can only be operated in those devices, for which it is actually determined.

The current client-specific operation key, which is currently stored in the memory element of the cash box and by means of which the data sent by the cash box and received by the cash box are encrypted, or, respectively decrypted, can in particular be changed only by means of this current client-specific operation key. This is in particular achieved in that only the received data, which are encrypted with the current client-specific operation key, are processed by the cash box, or, respectively, the memory element of the cash box. Data, which are encrypted with another operation key, cannot be decrypted by the cash box and unencrypted data are in particular not executed. Thus, it is in particular achieved that a communication between the cash box and another device is only possible via data encrypted with the current client-specific operation key and thus also a change of the operation key can only take place with the knowledge of the current client-specific operation key.

The memory element of the cash box in particular comprises a flash memory, in which the data of the production bootstrap loader, the data of the operation bootstrap loader, the production key and/or the operation key are stored. Thus, a simple construction of the memory element of the cash box is guaranteed.

In the memory element of the cash box preferably a firmware for operating the cash box is stored. The signature is in particular a one-key message authentication code (OMAC), which is based on a block encryption algorithm.

In a preferred embodiment of the invention, the client-specific operation key is stored as part of this firmware. Hereby, a particularly high level of security is achieved, as a manipulation of the client-specific operation key usually results in the firmware being manipulated as well and thus operating of the cash box is not possible anymore.

The firmware comprises in particular a signature. The control unit determines dependent on this signature the permissibility of the firmware by checking by means of the signature, if the firmware has been changed. The signature is in particular a signature, which unambiguously identifies the manufacturer of the cash box and/or a service company, which is entrusted with the maintenance of the cash box. Operating of the cash box is in particular only possible, if the signature of the firmware unambiguously identifies this manufacturer or, respectively, this service company, which is also actually entitled to change the firmware and/or when the control unit has determined by means of the signature that the signature has not been impermissibly changed.

If the check of the permissibility should show that the firmware comprises a diverging and thus wrong signature, operating of the cash box is not possible. Hereby, a manipulation of the firmware and a manipulation of the cash box is prevented. The check of the firmware takes in particular place with each booting of the cash box. Additionally or alternatively, this check can also take place in preset time intervals.

Further it is advantageous, if the firmware can only be changed by means of the client-specific operation key. Hereby it is achieved that the firmware can only be changed by authorized persons, i.e. by persons, which possess of the client-specific key themselves. Thus, a manipulation of the firmware and thus the cash box is prevented. In particular, the memory unit of the cash box only executes the data transmitted thereto, which are encrypted with the client-specific operation key. Data, which are encrypted with another key, cannot be decrypted by the cash box and data, which are not encrypted at all, are not processed by the cash box. Preferably, the signature transmitted together with the firmware is encrypted by means of the client-specific operation key, so that the signature can only be processed and/or changed by means of the client-specific operation key.

### BRIEF DESCRIPTION OF THE DRAWINGS

The drawings described herein are for illustrative purposes only of selected embodiments and not all possible implementations, and are not intended to limit the scope of the present disclosure.

Further features and advantages of the invention result from the following description which in connection with the enclosed Figures explains the invention in more detail with reference to embodiments.

FIG. 1 shows a schematic illustration of a cash box;

FIG. 2 shows a schematic illustration of an automated teller machine and the cash box inserted in this automated teller machine according to FIG. 1;

FIG. 3 shows a sequence of operation diagram of a process for commencing operation of the cash box;

FIG. 4 shows a schematic illustration of the operating of the cash box according to a first embodiment;

FIG. 5 shows a schematic illustration of the operating of the cash box according to a second embodiment;

FIG. 6 shows a schematic illustration of the operating of the cash box according to a third embodiment; and

FIG. 7 shows a schematic illustration of the operating of the cash box according to a fourth embodiment.

Corresponding reference numerals indicate corresponding parts throughout the several views of the drawing.

### DETAILED DESCRIPTION OF THE PREFERRED EMBODIMENTS

Example embodiments will now be described more fully with reference to the accompanying drawing.

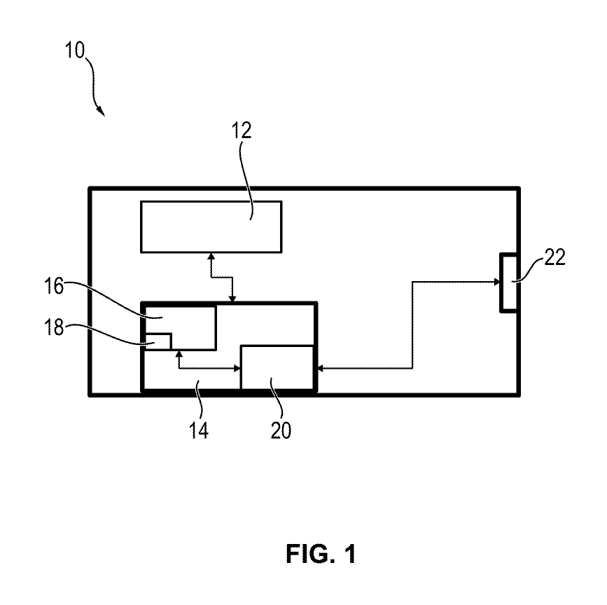

In FIG. 1, a schematic illustration of a cash box 10 is illustrated. The cash box 10 comprises a devaluating unit 12 for irreversibly devaluating non-illustrated notes of value received in the cash box and a control unit 14 for controlling the devaluating unit 12. The control unit 14 controls the devaluating unit 12 in particular such that this devaluating unit 12 devaluates the notes of value received in the cash box 10 when a manipulation attempt takes place. For this, the cash box 10 in particular comprises a plurality of non-illustrated sensors by means of which manipulation attempts are detectable. Such sensors can for example be position sensors, vibration sensors, gas sensors, liquid sensors and/or sensors for determining the opening of a cover of the cash box 10.

The devaluating unit 12 is in particular designed in the form of a so-called ink kit which upon activation irreversibly dyes the notes of value received in the cash box 10 by means of a dyestuff, so that these dyed notes of value cannot be put into circulation by a potential thief and are thus valueless for him.

The notes of value can be received in the cash box 10 both in a stacked manner in a receiving area and wound up on a drum storage. Such a drum storage comprises in particular two foil tapes, between which the notes of value are received.

The control unit 14 comprises a microprocessor 16, a first memory element 18 and a second memory element 20. The first memory element 18 and the second memory element 20 are in particular respectively designed in the form of a non-volatile memory, for example in the form of a flash memory or an EEPROM. In an alternative embodiment, the first and the second memory element 18, 20 can also be designed in the form of other types of memory elements. Further, it is alternatively possible that the control unit 14 only comprises one memory element 18, 20. In the second memory element 20 in particular data with information about the stock of the cash box 10 of notes of value, data with information about manipulation attempts and/or data with information about the maintenance of the cash box 10 are stored.

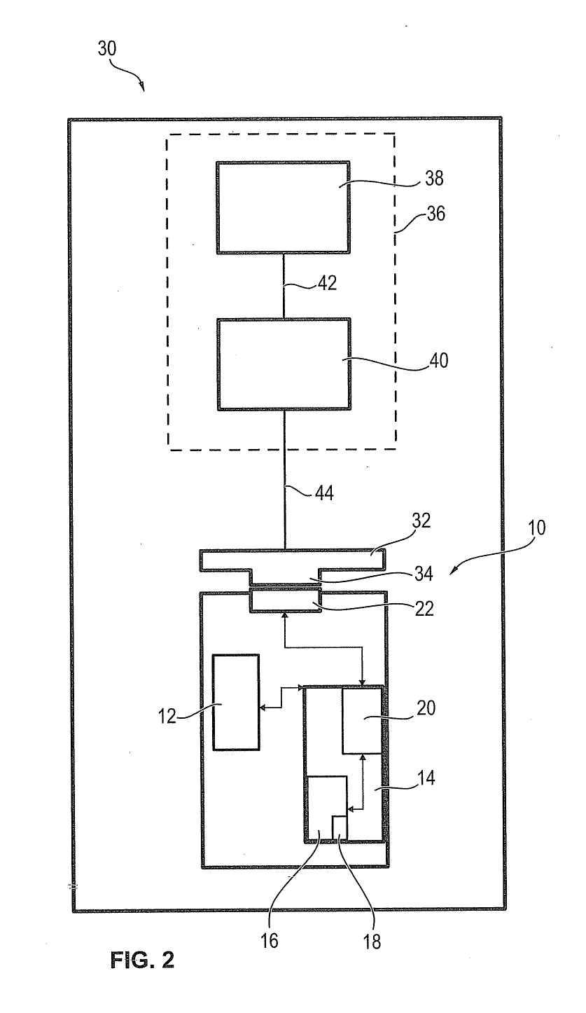

In the first memory element 18 in particular data of a firmware for operating a cash box 10 and data of a bootstrap loader for booting the cash box 10 are stored. The firmware comprises in particular a random number generating algorithm for generating random numbers and at least one key for encrypting data to be sent and decrypting received data. The encryption and decryption of the data as well as the administration of the keys used therefor are explained in more detail below in combination with FIGS. 2 to 7.

Further, the cash box 10 has a plug connector 22, via which a data transmission connection can be established between the cash box 10 and devices 30, in which the cash box 10 is inserted. In an alternative embodiment, additionally or alternatively to the plug connector 22 still another sending and/or receiving unit for sending and/or receiving data can be provided. In particular, sending and receiving of the data can also be carried out wireless, for example via mobile radio.

In FIG. 2, it is illustrated how the cash box 10 is inserted in a device 30. This device 30 can for example be an automated teller machine, an automatic cash safe, an automatic cash register system and/or a rack for intermediately storing cash boxes 10. Such a rack can for example be arranged in a value transport vehicle.

The device 30 comprises a sending and receiving unit 32 for sending data to the cash box 10 and for receiving data from the cash box 10. This sending and receiving unit 32 has a plug connector 34 which is formed complementary to the plug connector 22 of the cash box 10, so that, when, as shown in FIG. 2, the cash box 10 is inserted in the device 10, a data transmission connection is establishable via the plug connection established between the plug connectors 34 and 22.

Further, the device 30 has a control unit 36, which in the embodiment shown in FIG. 2 comprises a first sub-control unit 38 and a second sub-control unit 40, which are connected via a USB data transmission connection 42 with each other. In an alternative embodiment of the invention, the control unit 36 can also not comprise two sub-control units 38, 40, but be formed as an only control unit 36. The control unit 36, in particular the second sub-control unit 40, is connected via a CAN bus 44 for data transmission with the sending and receiving unit 32. Thus, a transmission of data between the control unit 36 of the device 30 and the control unit 14 of the cash box 10 can take place via the data transmission connection established between the plug connectors 22, 34.

The first sub-control unit 38 is in particular a computer, on which a customary software for operating this computer, in particular a standard operating system, is used. The second sub-control unit 40 is in particular an electronics specifically developed for the device 30, on which program data of a master firmware, which is specifically adapted for the use in the device 30 and the handling of the security relevant data are used. In an alternative embodiment of the invention, also other sub-control units 38, 40 can be used. In particular, the data transmission connections 42, 44 can also not be formed, unlike as described above, via a USB data transmission connection or, respectively, a CAN bus, but via other data transmission connections.

The cash box 10 can be operated in different operating modes, wherein in a switched off operating mode the control unit 14 does not activate the devaluating unit 12, irrespective of whether or not a manipulation attempt is detected by the sensors. However, in an activated operating mode all sensors are activated, so that the control unit 14, when at least one of these sensors detects a manipulation attempt, activates the devaluating unit 12, so that the notes of value received in the cash box 10 are devaluated. In a transport mode, only a part of the sensors are activated. In particular, in the transport mode the position sensors are deactivated.

When the cash box 10 is received in the device 30, via the data connection established between the plug connectors 22, 34 in particular data can be transmitted, by means of which the operating mode of the cash box 10 can be adjusted. Further, via the transmitted data also further security relevant adjustments of the cash box 10, such as for example the determination of timers for individual process steps, can be adjusted or, respectively, changed during the operation of the cash box 10.

In order to prevent manipulation attempts, in particular an unauthorized adjustment of the operating modes or the timers, and to protect confidential data, the data are transmitted in an encrypted manner via the data transmission connection between the sending and receiving unit 32 and the cash box 10. For this, in the control unit 36 of the device 30 and in the memory element 18 of the control unit 14 of the cash box 10 a client-specific operation key is stored. This client-specific operation key ensures that the cash box 10 can only be operated in those devices 30, which the client, i.e. the operator of the cash box 10, operates, i.e. those devices 30, for which the cash box 10 shall be used. By those client-specific operation keys it is in particular achieved that, when the cash box 10 is inserted in foreign devices, the adjustments of the cash box (10) cannot be changed and no data can be read out from the cash box 10. Thus, the security is further increased.

The encryption by means of the client-specific operation key in particular takes place via a block encryption algorithm, for which purpose data of this block encryption algorithm are stored in the control unit 30 and the control unit 14 and these data are executed during the encryption.

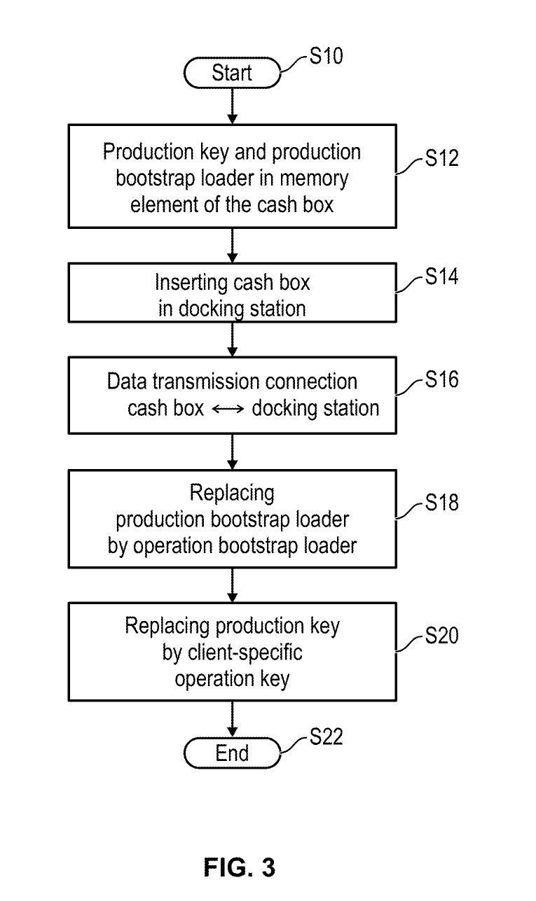

In FIG. 3, a flow chart of the sequence of the commencement of operation of the cash box 10 is illustrated. After the process has been started in step S10, in step S12 during the manufacture of the cash box 10 in the factory data of a production bootstrap loader for booting the cash box 10 and a production key for encrypting the data to be sent from the cash box 10 and for decrypting received data are stored in the memory element 18 of the memory unit 14 of the cash box 10. This production key and this production bootstrap loader are stored uniformly in the respective memory element 18 with all cash boxes 10 manufactured by the manufacturer of the cash boxes 10, so that irrespective of the cash box 10 all data to be transmitted during the commencement of operation and/or all functional tests can take place before the delivery of the cash box 10 to the client by means of this production key and this production bootstrap loader.

Subsequently, in step S14 the cash box is inserted in a so-called docking station and in step S16 a data transmission connection between the cash box 10 and the docking station is established. Next, in step S18 data of a production bootstrap loader are transmitted via this data transmission connection from the docking station to the cash box 10, wherein these data of the operation bootstrap loader replace the data of the production bootstrap loader. By replacing it is generally understood, that only exclusively the operation bootstrap loader and not anymore the production bootstrap loader is usable. For this, the data of the production bootstrap loader in the memory element 18 can be overwritten by the data of the operation bootstrap loader. Alternatively, it is possible that both the data of the production bootstrap loader and the data of the operation bootstrap loader are stored in the memory element 18, but the data of the production bootstrap loader are losing their validity.

In a preferred embodiment of the invention, the docking station encrypts the data of the operation bootstrap loader with the production key and the control unit 14 of the cash box 10 decrypts the transmitted data correspondingly with the production key. Thus, a secure data transmission is achieved.

Subsequently, in step S20 data with a client-specific operation key are transmitted from the docking station to the cash box 10, wherein this client-specific operation key replaces the production key. Hereby, preferably the docking station in turn encrypts this client-specific operation key with the production key and transmits the corresponding data in an encrypted manner to the cash box 10, which in turn decrypts the received data with the production key and replaces the production key by the client-specific operation key. Subsequently, the process is terminated in step S22.

By this process it is achieved that first during the manufacture of the cash boxes 10 uniform production keys and production bootstrap loaders can be used, so that the functional test of the cash boxes 10 can take place uniformly and a uniform fabrication is possible. The individualization of the cash box 10 corresponding to the specific client only takes place upon commencement of operation, so that subsequently during the operation of the cash box 10 this cash box 10 can only be operated in devices 30, which also have the client-specific operation keys. Thus, altogether a simple manufacture of the cash box 10 and still a high client-specific security is achieved.

In an alternative embodiment of the invention, the steps S18 and S20 can also be exchanged, i.e. first the client-specific operation key and then the operation bootstrap loader can be transmitted. Further, it is alternatively possible that the operation bootstrap loader and the client-specific operation key are transmitted together in one step.

A change of the client-specific operation key is in particular only possible with knowledge of the client-specific operation key currently stored in the memory element 18. Without the client-specific operation key currently stored in the memory element 18 the client-specific operation key cannot be changed. For this, the control unit 14 is in particular construed such that it only processes data or, respectively, executes commands, which are encrypted by means of the client-specific operation key currently stored in the memory element 18. The data which are encrypted with another key and/or were transmitted in an unencrypted manner to the control unit 14, are in contrast not processed or, respectively, the corresponding commands are not executed.

The firmware of the cash box 10 in particular includes a signature, which unambiguously identifies the originator of the firmware and/or which ensures, that the firmware has not been changed. The operation bootstrap loader preferably comprises a signature key, by means of which the control unit 14 can check whether the firmware has been created by the authorized manufacturer and/or if the firmware has been changed during the transmission. If the control unit 14 determines, that the manufacturer of the signature stored in the memory element 18 was not authorized thereto and/or that the firmware has been changed, an operating of the cash box 10 is not possible and in particular an error message is stored in the second memory element 20 and/or an error message is output. The signature key corresponds in particular to the client-specific operation key. The signature is in particular an electronic signature, preferably a digital signature.

In this manner it is prevented that the firmware is manipulated. Thus, the security is further increased, as by preventing the manipulation of the firmware also avoiding of the encryption via the operation key is excluded.

Additionally or alternatively to the signature, changing of the firmware can also be prevented in that a change of the firmware is only possible with knowledge of the client-specific operation key. Without client-specific operation key the firmware cannot be changed, so that unauthorized persons have no access thereto.

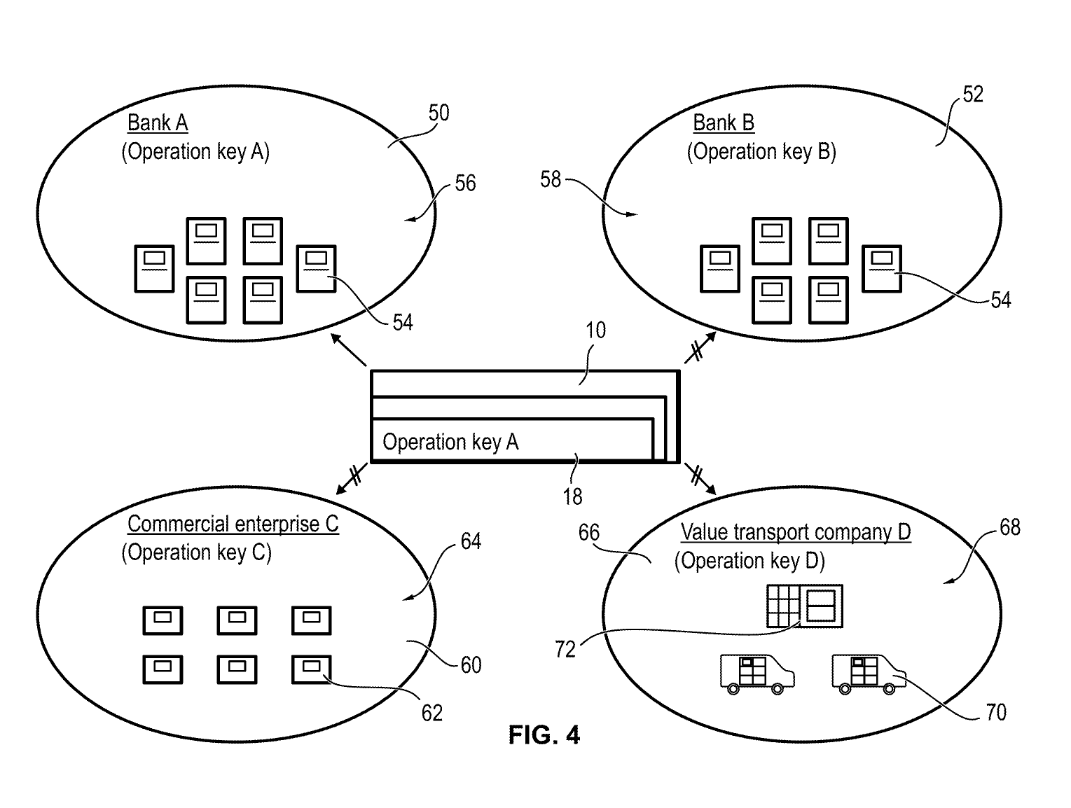

In FIG. 4, a schematic illustration of the operation of the cash box 10 according to a first embodiment is shown. In this embodiment, in the first memory element 18 of the cash box 10 only a first client-specific operation key A is stored.

Further, in FIG. 4, two banks 50, 52 are illustrated which respectively operate a device group 56, 58 comprising a plurality of automated teller machines 54. Further, a commercial enterprise 60 is illustrated, which operates a device group 64 consisting of a plurality of automatic cash safes 62. Furthermore, a value transport company 66 is schematically shown, which has a device group 68, comprising several value transport vehicles 70, in which respectively at least one rack 72 for receiving cash boxes 10 is available.

The first bank 50 uses its first operation key A for the data transmission between the automated teller machines 54 of its device group 56 and the cash boxes 10 inserted in these automated teller machines 54. In contrast to this, the second bank 58 uses an operation key B differing from the first operation key A for the automated teller machines 54 of its device group 58. Likewise, also the commercial enterprise 60 and the value transport company 66 use proper client-specific operation keys C, or, respectively, D for the communication of the devices 62, 72 of their device groups 64, 68 with cash boxes 10.

As in the first embodiment only the client-specific operation key A is stored in the cash box 10, the cash box 10 can only be operated in the automated teller machines 54 of the first device group 56 of the first bank 50. If the cash box 10 is inserted in an automated teller machine 54 of the second device group 58, an automatic cash safe 62 of the third device group 64 or a rack 72 of the fourth device group 68, a communication between the cash box 10 and the corresponding device 54, 62, 72 cannot take place, as the control unit 14 of the cash box 10 cannot decrypt the encrypted data transmitted by the device 54, 62, 72 and vice versa the devices 54, 62, 72 cannot decrypt the data transmitted by the cash box 10 to the devices 54, 62, 72.

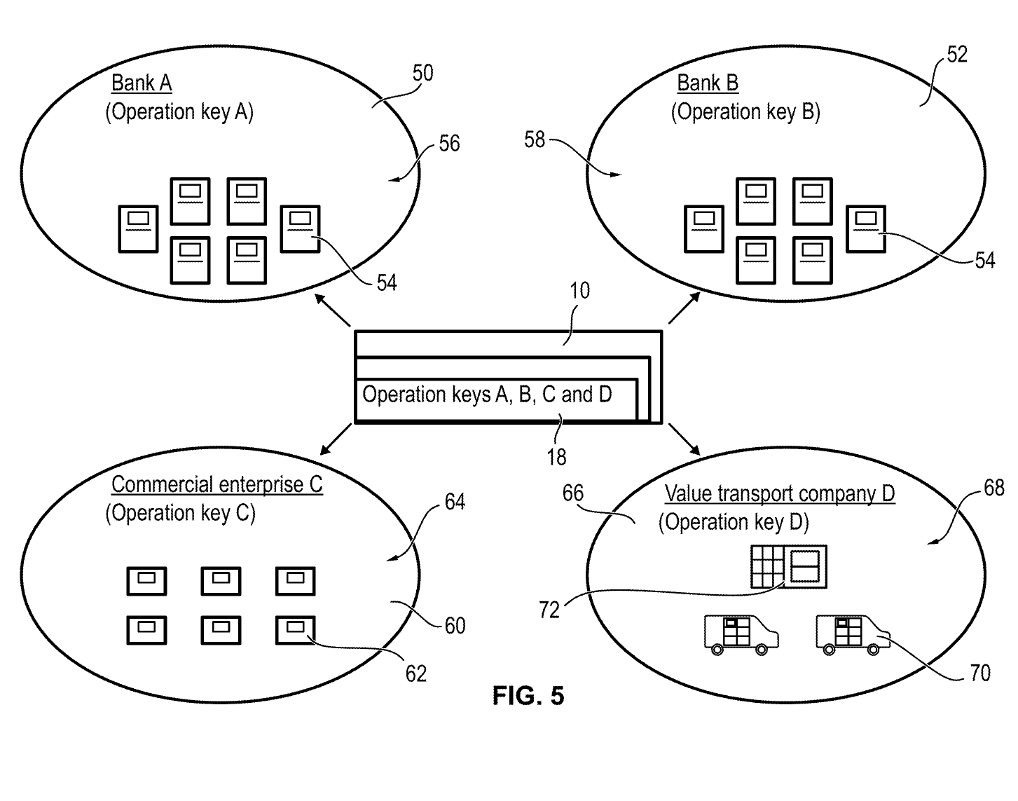

In FIG. 5, a schematic illustration of the operation of the cash box 10 according to a second embodiment is shown. In this second embodiment, in the memory element 18 of the cash box 10 the client-specific operation key A, the client-specific operation key B, the client-specific operation key C as well as the client-specific operation key D are stored. Thus, a communication between the cash box 10 and the automated teller machine 54 of the first device group 56, the cash box 10 and the automated teller machines 54 of the second device group 58, the cash box 10 and the automatic cash safes 62 of the third device group 64 and the cash box 10 and the racks 72 of the fourth device group 68 is possible, so that the cash box 10 can be operated in all four device groups 56, 58, 64, 68.

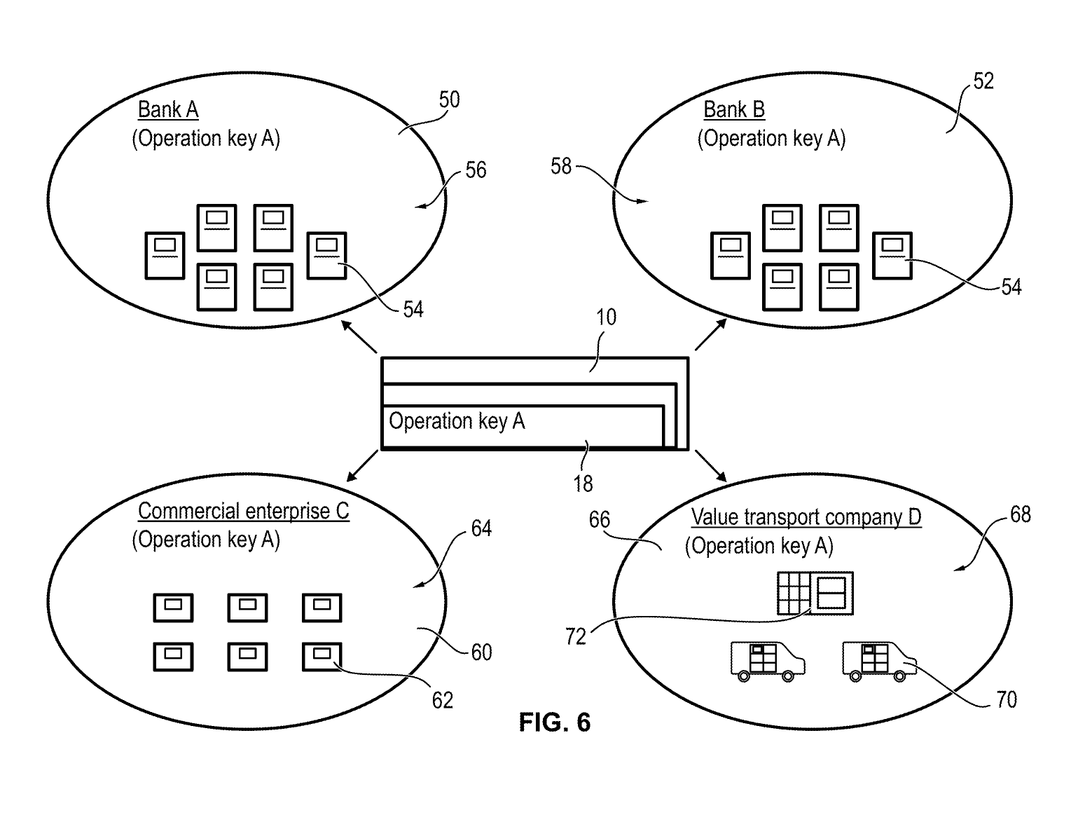

In FIG. 6, a schematic illustration of the operation of the cash box 10 according to a third embodiment is shown. In this third embodiment, in the memory element 18 of the cash box 10 only the first client-specific operation key A is stored. In contrast to the first two embodiments, the first bank 50 provides its client-specific operation key A both to the second bank 52 as well as to the commercial enterprise 60 and the value transport company 66, so that also the devices of the device groups 58, 64, 68 can use this client-specific operation key A for the communication with the cash box 10, so that the cash box 10 can be operated in all four device groups 56, 58, 64, 68.

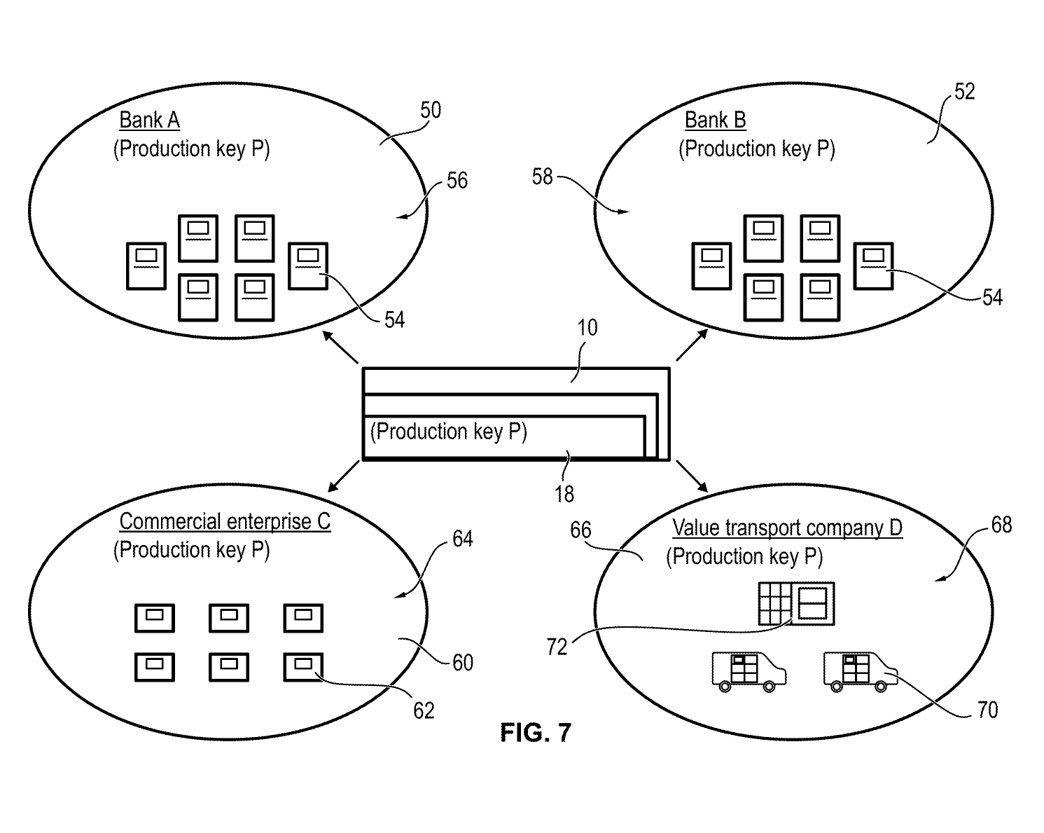

In FIG. 7, a schematic illustration of the operation of the cash box 10 according to a fourth embodiment is shown. In this fourth embodiment, the production key P in the memory element 18 was not replaced by a client-specific operation key. In particular, the process according to FIG. 3 for commencement of operation of the cash box 10 was not executed. The banks 50, 52, the commercial enterprise 60 and the value transport company 66 also have this standardized production key P, so that the cash box 10 can be operated in all device groups 56, 58, 64, 68.

In the first memory element 18 in particular at least 64 bit are reserved for the client-specific operation key. In a preferred embodiment, not only a client-specific operation key, but 32 different client-specific operation keys can be stored in the first memory element 18. To make this possible, in case of a key length of at least 64 bit at least 256 byte of the memory element 18 are reserved for the client-specific operation keys.

The communication between the cash box 10 with the devices 30, 54, 62, 72 takes in particular place via a so-called challenge response process. In this challenge response process, the device 30, 54, 62, 72 first transmits a command to the cash box 10 to generate a random number. In the control unit 14 a random number generating algorithm is stored by means of which the control unit 14 of the cash box 10 thereupon generates a random number. In order that this random number cannot be intercepted by third parties, the cash box 10 encrypts the random number by means of a challenge key and transmits the encrypted random number subsequently to the device 30, 54, 62, 72. The device 30, 54, 62, 72 thereupon decrypts the data received by the cash box 10 by means of this challenge key and generates data with information about a command to be executed by the cash box 10, wherein these data comprise the random number. The device 30, 54, 62, 72 encrypts these data via the client-specific operation key and transmits the encrypted data to the cash box 10, which thereupon decrypts the data again by means of the client-specific operation key.

Subsequently, the control unit 14 compares the random number contained in the data with the random number originally generated by the random number algorithm. If the two random numbers are identical, the cash box 10 executes the command contained in the data. However, if the random numbers are not identical, the cash box 10 does not execute the command and generates data with information about an error message, which it transmits to the device 30, 54, 62, 72.

By the above-described challenge response process a high level of transmission security is achieved. Thus, in particular manipulation attempts are prevented.

In an alternative embodiment of the invention, also other than the above-described challenge response process can be used for the communication between the cash box 10 and the device 30, 54, 62, 72. Furthermore, it is alternatively possible that also communication processes other than a challenge response process can be used for this communication.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A process for operating a cash box, comprising:
wherein during manufacture of the cash box in a memory element of a control unit of the cash box program data of a production bootstrap loader for booting the cash box and a production key for encrypting data sent by the cash box and/or for decrypting received data are factory-stored,
wherein the cash box for commencing operation is inserted in a device for receiving cash boxes and a data transmission connection is established between the device and the cash box, and
wherein the program data of the production bootstrap loader are replaced by program data of an operation bootstrap loader for booting the cash box and the production key is replaced by a client-specific operation key for encrypting data sent by the cash box and/or for decrypting received data.

2. The process according to claim 1, wherein the production bootstrap loader is replaced by a client-specific operation bootstrap loader.

3. The process according to claim 1, wherein the production bootstrap loader first is replaced by a standard operation bootstrap loader, that subsequently data with information about the client-specific operation key are transmitted via the data transmission connection from the device to the cash box, and that the production key is then replaced by the client-specific operation key.

4. The process according to claim 3, wherein the device encrypts the data with the information about the client-specific operation key by means of the production key, and that the control unit of the cash box decrypts these data by means of the production key.

5. The process according to claim 1, wherein the program data of the operation bootstrap loader and/or the client-specific operation key are first encrypted by the device by means of the production key, are then transmitted in an encrypted manner via the data transmission connection to the cash box, and subsequently decrypted by the control unit of the cash box by means of the production key.

6. The process according to claim 4, wherein the data are encrypted by means of a block encryption algorithm.

7. The process according to claim 1, wherein the client-specific operation key is stored in a memory element of at least one device for handling notes of value, in which the cash box shall be inserted during operation, and that data transmitted between this device and the cash box inserted in the device are transmitted in an encrypted manner by means of the client-specific operation key.

8. The process according to claim 1, wherein several client-specific operation keys are stored in the memory element, that in memory elements of several devices for handling notes of value respectively at least one of these operation keys is stored, and that respectively data transmitted between one of these devices and the cash box inserted in this device are transmitted in an encrypted manner by means of the corresponding client-specific operation key.

9. The process according to claim 1, wherein the data are transmitted between the cash box and the device for handling notes of value in a challenge response process.

10. The process according to claim 9, wherein in the challenge response process in a first step data with information for the request of a random number are transmitted from the device for handling notes of value to the cash box, that in a second step the cash box generates a random number by means of a random number generating algorithm stored in the control unit and transmits this random number in an encrypted manner to the device, that in a third step the device decrypts the encrypted random number and generates data with at least one control command, wherein these data comprise the random number, that in a fourth step the device encrypts these data with the client-specific operation key and transmits them to the cash box, that in a fifth step the cash box decrypts these data transmitted to it by means of the client-specific operation key and compares the random number contained therein with the random number generated and transmitted in the second step, and that the cash box only executes the command transmitted by the device, if the comparison shows that the random numbers are identical.

11. The process according to claim 1, wherein the client-specific operation key can only be changed by means of the current client-specific operation key.

12. The process according to claim 1, wherein the memory element of the cash box comprises a non-volatile memory, in particular a flash memory, in which the data of the production bootstrap loader, the data of the operation bootstrap loader, the production key and/or the operation key are stored.

13. The process according to claim 1, wherein in the memory element of the cash box a firmware for operating the cash box is stored, and that the client-specific operation key is stored as part of this firmware.

14. The process according to claim 1, wherein a firmware for operating the cash box is stored in the memory element of the cash box, that the firmware comprises a signature, and that the control unit of the cash box determines the permissibility of the firmware dependent on the signature.

15. The process according to claim 1, wherein a firmware for operating the cash box is stored in the memory element of the cash box, and that the firmware can only be changed by means of the current client-specific operation key.
